(19) United States
(12) Patent Application Publication
(10) Pub. No.: US 2012/0023899 A1
(43) Pub. Date: Feb. 2, 2012

(54) TURBOFAN ENGINE

(76) Inventor: Shoji Yasuda, Aichi (JP)

(21) Appl. No.: 13/148,064

(22) PCT Filed: Feb. 6, 2009
(86) PCT No.: PCT/JP2009/052083

§ 371 Date: Aug. 5, 2011

(51) Int. Cl. F02K 3/072

(52) U.S. Cl. 60/224

(57) ABSTRACT

Provided is a turbofan engine capable of effectively using the air flowing through the inner diameter side area of a fan that is disposed at the front end side. The turbofan engine in which the fan is disposed at the front end side is equipped with a first low-pressure compressor at the upstream side and on the inner diameter side of the fan. Accordingly, the first low-pressure compressor can be operated by effectively using the air flowing through the rotation center portion of the fan, so that the air can be efficiently used and the output of the engine can be increased.

### TECHNICAL FIELD

The present invention relates to a turbofan engine used in airplanes or the like.

### BACKGROUND ART

In the related art, a turbofan engine is disclosed in Japanese Unexamined Patent Application Publication No. 2003-286857, in which a fan is installed at the front end portion of an engine, and a compressor, an engine core unit, and a turbine are disposed at the downstream side of the fan. The engine includes a counterrotating fan which is driven by a counterrotating low-pressure turbine rotor.

### CITATION LIST

Patent Literature 1
Japanese Unexamined Patent Application Publication No. 2003-286857

### SUMMARY OF INVENTION

### Technical Problem

However, in such an engine, there is a problem in that the air flowing through the inner diameter side area of the fan that is disposed at the front end side cannot be effectively used. That is, since the inner diameter side of the fan is provided with a spinner, it is impossible to dispose the compressor. For this reason, it is difficult to improve the compression efficiency of the air by using the flow of the air through the inner diameter side of the fan.

Accordingly, the present invention has been made to solve the problems in the related art, and an object of the present invention is to provide a turbofan engine capable of effectively using the air flowing through the inner diameter side area of the fan that is disposed at a front end portion.

### Solution to Problem

That is, the turbofan engine according to the present invention, in which a fan is disposed at a front end side thereof, includes a first compressor that is disposed at an upstream side of the fan.

According to the present invention, since the first compressor is disposed at the upstream side of the fan, the first compressor can be driven by effectively using the air flowing through the rotation center portion of the fan. For this reason, it is possible to improve the output of the engine since the air is effectively used.

In addition, in the turbofan engine according to the present invention, it is preferable that the first compressor be directly coupled to a turbine that is disposed at an engine core unit.

Furthermore, in the turbofan engine according to the present invention, it is preferable that the first compressor be installed so as to rotate at a speed faster than the fan.

Moreover, in the turbofan engine according to the present invention, it is preferable that the first compressor be installed on an inner diameter side of the fan. In this instance, since the first compressor is installed on the inner diameter side of the fan, even though the first compressor is disposed at the upstream side of the fan, the compressor has a small effect on the rotation of the fan. Therefore, the first compressor can be driven by effectively using the air flowing through the rotation center portion of the inner diameter side of the fan. For this reason, an improvement in the output of the engine is possible. Accordingly, an improvement in propulsion efficiency, and thereby a reduction in fuel consumption is possible.

In addition, in the turbofan engine according to the present invention, it is preferable that it include a second compressor that is installed at a downstream side of the first compressor and on the inner diameter side of the fan. According to the present invention, since the second compressor is installed at the downstream side of the first compressor and on the inner diameter side of the fan, a boost compression mechanism can be formed by a plurality of stages of compression. For this reason, it is possible to decrease the load for every stage. Further, it is possible to make an improvement in the output of the engine by effectively using the flow of the air through the inner diameter side of the fan.

Further, in the turbofan engine according to the present invention, it is preferable that the second compressor includes a cascade, that is separated by a shroud, on the inner diameter side of the fan.

Furthermore, in the turbofan engine according to the present invention, it is preferable that the second compressor be installed so as to be counterrotated with respect to the first compressor. According to the present invention, since the second compressor is installed so as to be counterrotated with respect to the first compressor, a counterrotating boost compression mechanism can be formed by a plurality of stages of compression. For this reason, it is possible to decrease the load for every stage by the counterrotating. Further, it is possible to make an improvement in the output of the engine by effectively using the flow of the air through the inner diameter side of the fan.

Also, in the turbofan engine according to the present invention, it is preferable that the first compressor be installed so as to rotate at a speed faster than the second compressor.

In addition, in the turbofan engine according to the present invention, it is preferable that the first compressor includes first moving blades arranged along a circumferential direction, in which the first moving blades are formed in such a way that the radius of the first moving blades increases from an inlet side to an outlet side. According to the present invention, since the first moving blades of the first compressor are formed largely from the inlet side to the outlet side, the air formed by the first compressor flows along the direction of centrifugal force, so that, as the rotation speed of the first compressor increases, the flow of the air becomes strong due to the centrifugal force. For this reason, an appropriate circumferential velocity is obtained depending upon the rotation speed.

Further, in the turbofan engine according to the present invention, it is preferable that it includes a third compressor that is rotated as one unit with at least one of the first compressor or the second compressor. According to the present invention, a multiple-stage and inversion compression mechanism is configured by including the third compressor that is rotated as one unit with at least one of the first compressor or the second compressor. For this reason, a pressure ratio can be increased, thereby improving the fuel consumption and the thrust force per weight.

### Advantageous Effects of Invention

According to the present invention, it is possible to make an improvement in the output of the engine by effectively using the air flowing through the inner diameter side of the fan disposed at the front end portion.

### BRIEF DESCRIPTION OF DRAWINGS

FIG. 1 is a schematic diagram of a turbofan engine according to a first embodiment of the present invention.

FIG. 2 is a view illustrating the related art as a comparative embodiment.

FIG. 3 is a schematic view of a turbofan engine according to a second embodiment of the present invention.

### DESCRIPTION OF EMBODIMENTS

Now, embodiments of the present invention will be described with reference to the accompanying drawings. In the description of the drawings, like components will be designated by the like reference numerals, and the repetitive description thereof will be omitted herein.

### Embodiment 1

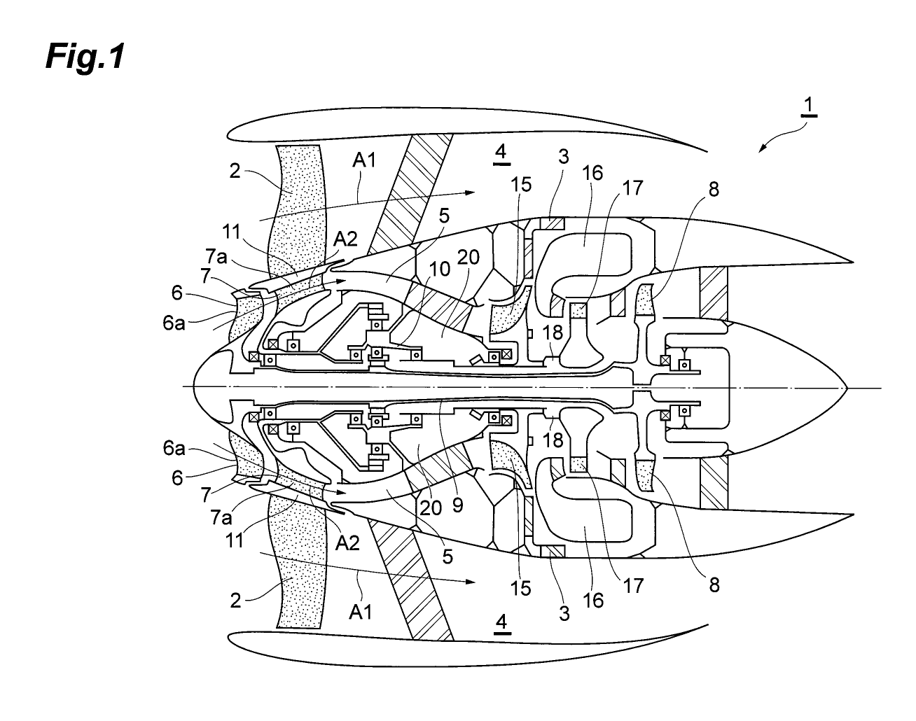

FIG. 1 is a cross-sectional view illustrating constituent elements of a turbofan engine according to a first embodiment of the present invention.

As shown in FIG. 1, a turbofan engine 1 according to this embodiment is a turbofan engine of a front fan type in which a fan 2 is disposed at a front end side. The turbofan engine 1 is provided with a bypass passage 4 around an engine core unit 3. The air A1 created by the fan 2 flows through the bypass passage 4, which serves as a part of a thrust force.

The engine core unit 3 configures a turbo jet, and is provided with a core flow channel 5 through which air A2 flows. The engine core unit 3 includes a first low-pressure compressor 6 and a second low-pressure compressor 7. The first low-pressure compressor 6 is disposed at the upstream side of the fan 2, and, for example, is disposed further toward a front end side than the fan 2. In addition, the first low-pressure compressor 6 is installed on the inner diameter side of the fan 2. That is, the first low-pressure compressor 6 is installed at an inner circumferential side in which the fan 2 is disposed.

The first low-pressure compressor 6 is configured by arranging a plurality of first moving blades 6a along a circumferential direction around the rotational shaft of the engine. The first moving blades 6a are disposed in the core flow channel 5. That is, the first moving blades 6a are disposed at an inlet portion of the core flow channel 5 and are rotated to circulate the air A2 to the rear portion of the core flow channel 5.

The first moving blade 6a is formed in such a way that the radius of the moving blade increases from an inlet side to an outlet side. That is, the diameter of the core flow channel 5, in which the first moving blade 6a is disposed, is increased toward the outlet side. Consequently, the air A2 formed by the first low-pressure compressor 6 can flow along the direction of a centrifugal force. For this reason, as the rotation speed of the first low-pressure compressor 6 is increased, the flow of the air A2 becomes strong due to the centrifugal force, thereby being advantageous to the performance of the compressor and obtaining the appropriate circumferential speed which is required for the second low-pressure compressor 7.

The first low-pressure compressor 6 is directly coupled to a low-pressure turbine 8 that is disposed behind the first low-pressure compressor. For example, the first low-pressure compressor 6 is mechanically coupled to the low-pressure turbine 8 through a first shaft 9, and is installed in such a way that it is rotated with the low-pressure turbine 8 as one unit.

In addition, it is preferable that the first low-pressure compressor 6 be installed so as to rotate at a speed faster than the fan 2.

For example, the fan 2 is configured to rotate relatively to the first low-pressure compressor 6 thorough a speed reducer 10. For example, a planetary gear mechanism is used as the speed reducer 10. The speed reducer 10 receives the rotation input of a first shaft 9 that is rotated together with the first low-pressure compressor 6, and reduces and outputs the rotation input to rotate the fan 2 through the second low-pressure compressor 7 and a shroud 11. The speed reducing ratio of the speed reducer 10 is set to 1:1 to 4:1, preferably 2:1 to 4:1.

The second low-pressure compressor 7 is installed in the core flow channel 5, and is disposed at the downstream side of the first low-pressure compressor 6. The second low-pressure compressor 7 is installed on the inner diameter side of the fan 2 through the shroud 11, and is rotated with the fan 2 as one unit.

The second low-pressure compressor 7 is configured by arranging a plurality of second moving blades 7a along the circumferential direction around the rotational shaft of the engine. The second moving blades 7a are disposed in the core flow channel 5, and are disposed at the downstream side of the first moving blade 6a.

The second moving blade 7a is formed in such a way that the radius of the moving blade increases from the inlet side to the outlet side. That is, the diameter of the core flow channel 5, in which the second moving blade 7a is disposed, is increased toward the outlet side. Consequently, the air A2 formed by the second low-pressure compressor 7 can flow along the direction of the centrifugal force. For this reason, as the rotation speed of the second low-pressure compressor 7 is increased, the flow of the air A2 becomes strong due to the centrifugal force, thereby obtaining the appropriate circumferential speed according to the rotation speed.

Since the second low-pressure compressor 7 is installed, a boost compression mechanism can be formed by a plurality of stages of compression due to the first low-pressure compressor 6 and the second low-pressure compressor 7. For this reason, it is possible to decrease the compression load for every stage, and thus improve the durability. Further, it is possible to improve the output of the engine 1 by effectively using the air A2 through the inner diameter side of the fan 2.

The second low-pressure compressor 7 is rotated by receiving the rotation output of the speed reducer 10, but the second low-pressure compressor is installed so as to be inverted with respect to the first low-pressure compressor 6. For example, the rotation output of the speed reducer 10 is inverted with respect to the first low-pressure compressor 6, thereby inverting the second low-pressure compressor 7 with respect to the first low-pressure compressor 6.

Since the second low-pressure compressor 7 is inverted with respect to the first low-pressure compressor 6, a counterrotating boost compression mechanism can be formed by a plurality of stages of compression. For this reason, it is possible to decrease the load for every stage by the counterrotating. Further, due to the counterrotating, it is not necessary to install a stator vane, thereby enabling reduction in size and production cost. Furthermore, it is possible to make an improvement in the output of the engine 1 by effectively using the flow of the air A2 through the inner diameter side of the fan 2.

At the downstream side of the second low-pressure compressor 7 in the core flow channel 5, a high-pressure compressor 15, a combustor 16, and a high-pressure turbine 17 are installed. The high-pressure compressor 15 is coupled to the high-pressure turbine 17 through a second shaft 18, and is rotated with the high-pressure turbine 17 as one unit. At the downstream side of the high-pressure turbine 17, a low-pressure turbine 8 is disposed.

An oil sump chamber 20 is installed between the high-pressure compressor 15 and the second low-pressure compressor 7. The oil sump chamber 20 houses a shaft bearing, a speed reducer, a gear mechanism, and the like. In the turbofan engine 1, since the first low-pressure compressor 6 and the second low-pressure compressor 7 are disposed at the front end side of the engine core unit 3, one oil sump chamber 20 can be installed between the low-pressure compressors 6 and 7 and the high-pressure compressor, thereby enabling a reduction in the size (shortening of the whole length) and weight of the turbofan engine 1.

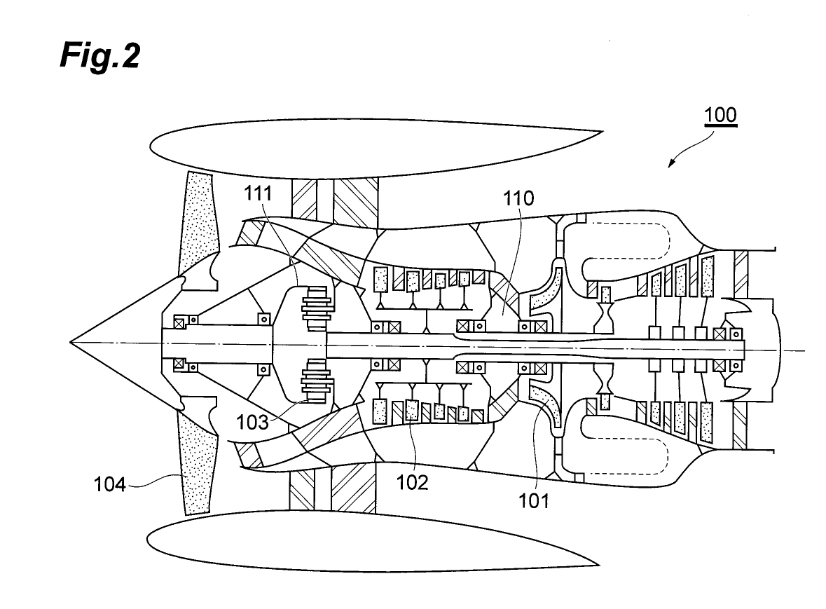

For example, as shown in FIG. 2, in the case of a type of the engine 100 in which a low-pressure compressor 102 is installed at the front side of a high-pressure compressor 101 and a speed reducer 103 is disposed at the front side of the low-pressure compressor 102 to drive a fan 104, it is necessary to install, in a plurality, an oil sump chamber 110 for the bearing of the high-pressure compressor 101 and an oil sump chamber 111 for fan driving, thereby increasing the size and weight of the engine 100.

Next, the operation of the turbofan engine 1 according to this embodiment will be described.

In FIG. 1, if the hot exhaust generated by combustion is ejected from the combustor 16, the high-pressure turbine 17 is rotated by the exhaust, and then the low-pressure turbine 8 is rotated. The high-pressure compressor 15 is rotated in accordance with the rotation of the high-pressure turbine 17, so that the air A2 is compressed and then flows through the core flow channel 5.

Meanwhile, the first shaft 9 is rotated in accordance with the rotation of the low-pressure turbine 8, and then the first low-pressure compressor 6 is rotated. As the first low-pressure compressor 6 is rotated, the air A2 flows through the core flow channel 5. In this instance, the first low-pressure compressor 6 is installed at the upstream side of the fan 2 and on the inner diameter side of the fan 2. For this reason, it is possible to effectively use the flow of the air through the place in which a spinner is disposed in the turbofan engine in the related art, thereby enabling an improvement in the compression efficiency and thus improving the output of the engine. In addition, the first low-pressure compressor 6 is rotated at a speed faster than the fan 2, and thus the first low-pressure compressor is rotated at a fast speed as compared with the spinner of the turbofan engine in the related art, thereby making it possible to carry out the effective air compression.

In addition, as the first shaft 9 rotates, the rotation force reduced by the speed reducer 10 is transmitted to the second low-pressure compressor 7. The second low-pressure compressor 7 is driven rotationally to form the counterrotating boost, thereby making it possible to carry out the high compression of the air A2 without difficulty. Further, it is possible to decrease the compression load for every stage of the compressor. Furthermore, it is not necessary to install the stator vane by inverting the rotation direction of the first low-pressure compressor 6 and the second low-pressure compressor 7, thereby making it possible to reduce the size and weight of the engine.

Since the first low-pressure compressor 6 and the second low-pressure compressor 7 are installed at the position of which the diameter of the core flow channel 5 is increased, the air A2 flows in the direction of the centrifugal force of the first low-pressure compressor 6 and the second low-pressure compressor 7. In the case where the rotation speed is increased, the flow of the air A2 becomes smooth to improve the compression efficiency.

In addition, as the first shaft 9 rotates, the rotation force reduced by the speed reducer 10 is transmitted to the fan 2. As the fan 2 is rotated, the air A1 flows through the bypass passage 4 to create the thrust force.

As described above, since the turbofan engine 1 according to this embodiment includes the first low-pressure compressor 6 that is disposed at the upstream side in which the fan 2 is disposed at the front end side, the first low-pressure compressor 6 can be driven by effectively using the air flowing through the rotation center portion of the fan 2. For this reason, it is possible to effectively use the air, and improve the output of the engine, thereby making it possible to improve the propulsion efficiency and reduce fuel consumption.

In addition, since the first low-pressure compressor 6 that is disposed on the inner diameter side of the fan 2 is rotated at the speed faster than the fan 2, it is possible to obtain the desired circumferential speed by the first low-pressure compressor 6 even on the inner diameter side, thereby making it possible to carry out the effective compression of the air.

Further, since the first low-pressure compressor 6 is installed on the inner diameter side of the fan 2, even though the first low-pressure compressor 6 is disposed on the upstream side of the fan 2, it has a small effect on the rotation of the fan 2. The first compressor can be driven by effectively using the air flowing through the rotation center portion of the inner diameter side of the fan 2.

Furthermore, since the second low-pressure compressor 7 is included at the downstream side of the first low-pressure compressor 6, it is possible to reduce the load for every stage. Also, it is possible to make an improvement in the output of the engine by effectively using the flow of the air through the inner diameter side of the fan 2.

In addition, since the second compressor is installed to counterrotate with respect to the first compressor, a counterrotating boost compression mechanism can be formed by a plurality of stages of compression. For this reason, it is possible to decrease the load for every stage by the counterrotating.

Further, since the first moving blade 6a of the first low-pressure compressor 6 is formed largely from the inlet side to the outlet side, the air A2 formed by the first low-pressure compressor 6 flows along the direction of centrifugal force, so that, as the rotation speed of the first low-pressure compressor 6 increases, the flow of the air A2 becomes strong due to the centrifugal force. For this reason, an appropriate circumferential velocity is obtained depending upon the rotation speed.

### Embodiment 2

Next, a turbofan engine according to a second embodiment of the present invention will be described.

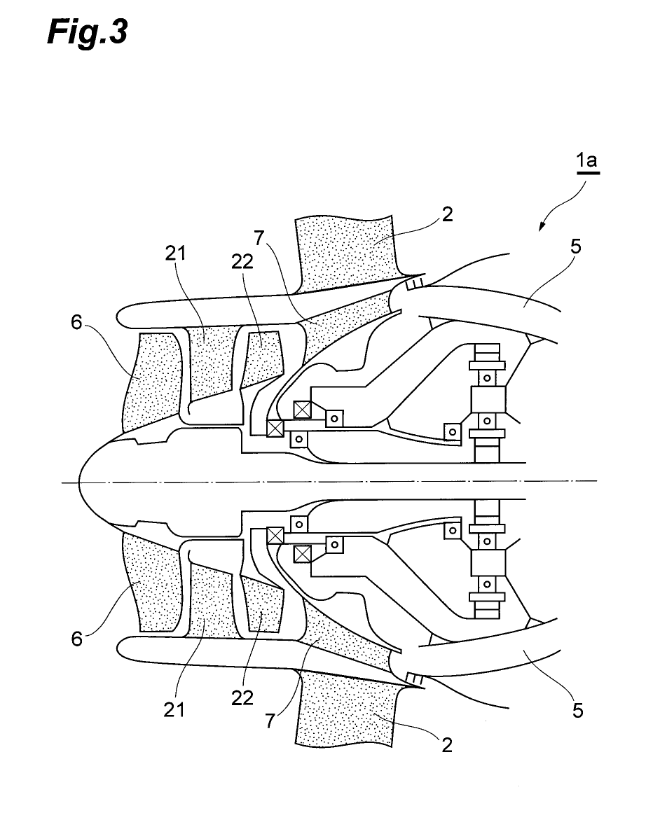

FIG. 3 is a cross-sectional view illustrating constituent elements of the turbofan engine according to the second embodiment of the present invention. The turbofan engine according to this embodiment is substantially identical to the turbofan engine 1 according to the first embodiment, except that three or more low-pressure compressors are disposed at the upstream side from the position of the fan 2.

As shown in FIG. 3, the turbofan engine 1a according to this embodiment includes a third low-pressure compressor 21 and a fourth low-pressure compressor 22, in addition to the first low-pressure compressor 6 and the second low-pressure compressor 7. The third low-pressure compressor 21 is coupled to the second low-pressure compressor 7, and thus is rotated as one unit. The third low-pressure compressor is installed at the downstream side of the first low-pressure compressor 6 and at the upstream side of the second low-pressure compressor 7. The third low-pressure compressor 21 is configured to be identical to the second low-pressure compressor 7 with respect to the inclusion of a plurality of moving blades.

The fourth low-pressure compressor 22 is coupled to the first low-pressure compressor 6, and thus is rotated as one unit. The fourth low-pressure compressor is installed at the downstream side of the third low-pressure compressor 21 and at the upstream side of the second low-pressure compressor 7. The fourth low-pressure compressor 22 is configured to be identical to the first low-pressure compressor 6 in view of including a plurality of moving blades.

With the turbofan engine 1a according to this embodiment, a multiple-stage and counterrotating compression mechanism is configured by the first low-pressure compressor 6, the second low-pressure compressor 7, the third low-pressure compressor 21, and the fourth low-pressure compressor 22. For this reason, a compression ratio can be increased by these low-pressure compressors 6, 7, 21 and 22, thereby improving the fuel consumption and the thrust force per weight.

In addition, if the number of stages in the compression ratio is increased, the whole length of the engine is extended to increase the weight of the engine. However, in the turbofan engine 1a according to this embodiment, since the space efficiency is high and the increased amount of components is low, it is possible to suppress the size and weight of the engine from being increased while configuring the multiple-stage and multiple-inversion compression mechanism.

As described above, with the turbofan engine 1a according to this embodiment, since the multiple-stage inversion compression mechanism is configured, the compression ratio can be increased, thereby improving the fuel consumption and the thrust force per weight.

In this embodiment, the case of the double-stage and counterrotating compression mechanism has been described, but the compression mechanism may be configured by omitting the installation of one of the third low-pressure compressor 21 and the fourth low-pressure compressor 22. Alternatively, three or more stages and counterrotating compression mechanism may be configured.

Each of the above-described embodiments illustrates one example of the turbofan engine according to the present invention. The turbofan engine according to the present invention is not limited to the turbofan engine according to the embodiments, and the turbofan engine according to the embodiments can be modified without altering the gist set forth in each claim, or may have other applications.

### INDUSTRIAL APPLICABILITY

According to the present invention, it is possible to make an improvement in the output of the engine by effectively using the air flowing through the inner diameter side of the fan disposed at the front end portion.

### REFERENCE SIGNS LIST

1: TURBOFAN ENGINE
2: FAN
3: ENGINE CORE UNIT
4: BYPASS FLOW CHANNEL
5: CORE FLOW CHANNEL
6: FIRST LOW-PRESSURE COMPRESSOR
7: SECOND LOW-PRESSURE COMPRESSOR
8: LOW-PRESSURE TURBINE

1.-10. (canceled)

11. A turbofan engine, in which a fan is disposed at a front end side thereof, comprising:
a first compressor is disposed at an upstream side of the fan; and
a second compressor that is installed at a downstream side of the first compressor and on an inner diameter side of the fan,
wherein the second compressor is installed so as to be counterrotated with respect to the first compressor.

12. The turbofan engine according to claim 11, wherein the first compressor is directly coupled to a turbine that is disposed at an engine core unit.

13. The turbofan engine according to claim 11, wherein the first compressor is installed so as to rotate at a speed faster than the fan.

14. The turbofan engine according to claim 11, wherein the first compressor is installed on an inner diameter side of the fan.

15. The turbofan engine according to claim 11, wherein the first compressor is installed on an inner diameter side of the second compressor.

16. The turbofan engine according to claim 15, wherein the second compressor includes a cascade, that is separated by a shroud, on the inner diameter side of the fan.

17. The turbofan engine according to claim 15, wherein the first compressor is installed so as to rotate at a speed faster than the second compressor.

18. The turbofan engine according to claim 11, wherein the first compressor includes first moving blades arranged along a circumferential direction, in which the first moving blades are formed in such a way that the radius of the first moving blades increases from an inlet side to an outlet side.

19. The turbofan engine according to claim 11, further comprising a third compressor that is rotated in one unit with at least one of the first compressor or the second compressor.
